(19) United States
(12) Patent Application Publication
(10) Pub. No.: US 2014/0258885 A1
(43) Pub. Date: Sep. 11, 2014

(54) PROFESSIONAL ADVICE AGGREGATION SYSTEM FOR ANONYMOUS USERS

(71) Applicant: Uniloc Luxembourg S.A., Luxembourg (LU)

(72) Inventor: Craig S. Etchegoyen, Plano, TX (US)

(73) Assignee: UNILOC LUXEMBOURG S.A., Luxembourg (LU)

(21) Appl. No.: 14/176,931

(22) Filed: Feb. 10, 2014

Related U.S. Application Data
(60) Provisional application No. 61/774,320, filed on Mar. 7, 2013.

(51) Int. Cl. H04L 29/06

(52) U.S. Cl. CPC H04L 65/403
USPC 715/753

(57) ABSTRACT

A forum server distinguishes credentialed professional users from other users while maintaining the anonymity of all users. All users supply information by which they are accurately and personally identified. Personally identifying information of credentialed professionals is used to very the credential of the user through a credential authority server. In a user forum, both lay and professionally credentialed users can participate. Lay users are prevented from rating messages posted by credentialed professional users. In a professional consultation forum, only credentialed professionals are permitted to participate. Credentialed professional users are provided with a user interface by which they can rate and comment upon messages posted by other credentialed professionals. Thus, the ratings of peers are well-informed ratings. When a credentialed professional user participates in either forum, the aggregate peer rating of the user is displayed.

### BACKGROUND OF THE INVENTION

This application claims priority to U.S. Provisional Application 61/774,320, filed Mar. 7, 2013, which is fully incorporated herein by reference.

1. Field of the Invention

The present invention relates generally to computer systems and, more particularly, to methods of and systems for aggregating professional advice from many sources.

2. Description of the Related Art

Web-based discussion forums are used for people with common interests to discuss those interests, leveraging from crowd sourcing to not only provide detailed information about those interests, but also to provide a searchable archive of that detailed information. However, such forums lack reliability when it comes to professional advice, such as legal or medical advice.

First, most forum users are anonymous. To the extent a forum user has a user name that identifies herself, there is no verification of the accuracy of such identification. Moreover, there is no verification that any user has a professional credential and any advice posted cannot be reasonably relied upon. While some users voluntarily post credential identification (such as a bar number for an attorney), it is very easy for unscrupulous users to pose as a credentialed professional and supply the credential identification. In other words, posting of a credential identifier does not guarantee that the posting user actually has the identified credential.

Second, anonymity of professionals participating in such forums is preferred by most credential professionals. Professional services are expensive for a reason. In order for a client to rely upon advice from a credentialed professional, the professional must take great care that the advice is, in fact, reliable and risks significant liability if the advice turns out to be inaccurate. Identifying oneself in a public forum in which quick assessments and off-the-cuff thoughts opens a professional to such liability.

Yet, such quick assessments and off-the-cuff thoughts are valuable and would be even more valuable if the source of such quick assessments and off-the-cuff thoughts were known to be a properly credentialed professional.

### SUMMARY OF THE INVENTION

In accordance with the present invention, a forum server distinguishes credentialed professional users from other users while maintaining the anonymity of all users. All users supply information by which they are accurately and personally identified. This personally identifying information for each user is kept in confidence and anonymous identifiers uniquely identify each user within the discussion forums. However, the personally identifying information of credentialed professionals is used to very the credential of the user through a credential authority server. For example, the American Board of Medical Specialties maintains data regarding certification of doctors in a number of specialties. Similarly, for legal professionals, state bar organizations maintain data regarding membership and standing of legal professionals. Many of these organizations provide network-based tools by which a person's credentials can be verified.

In a user forum, both lay and professionally credentialed users can participate. Credentialed professional users are identified as such in the forum. Lay users are prevented from rating messages posted by credentialed professional users.

In a professional consultation forum, only credentialed professionals are permitted to participate. Accordingly, professionals, though still anonymous, can ask questions of other professionals without appearing to be less than perfectly informed to lay users who might not fully appreciate the subtleties of various professional specialties. In addition, credentialed professional users are provided with a user interface by which they can rate and comment upon messages posted by other credentialed professionals.

Thus, credentialed professionals are rated only by other credentialed professionals who are presumably sufficiently well-informed to comment upon similarly credentialed users. In other words, the ratings of peers are well-informed ratings.

When a credentialed professional user participates in either forum, the aggregate peer rating of the user is displayed.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a forum server, a credential authority server, and client devices that cooperate to implement professional discussion forums in accordance with one embodiment of the present invention.

FIG. 2 is a block diagram showing in greater detail the forum server of FIG. 1.

FIG. 3 is a block diagram of a professional user record that represents a credentialed professional user.

FIG. 4 is a block diagram of a user record that represents a lay user.

FIG. 5 is a block diagram of a user forum message that represents a message authored by a lay user.

FIG. 6 is a block diagram of a professional forum message that represents a message authored by a credentialed professional user.

FIG. 7 is a block diagram of user forum logic of the forum server in greater detail.

FIG. 8 is a block diagram of professional consultation forum logic of the forum server in greater detail.

FIG. 9 is a logic flow diagram illustrating the manner in which the forum server of FIG. 2 registers users, both lay and professional.

FIG. 10 is a logic flow diagram illustrating the manner in which the forum server of FIG. 2 interacts with users, both lay and professional.

FIG. 11 is a logic flow diagram illustrating the manner in which the forum server of FIG. 2 aggregates ratings of credentialed professional users.

### DETAILED DESCRIPTION

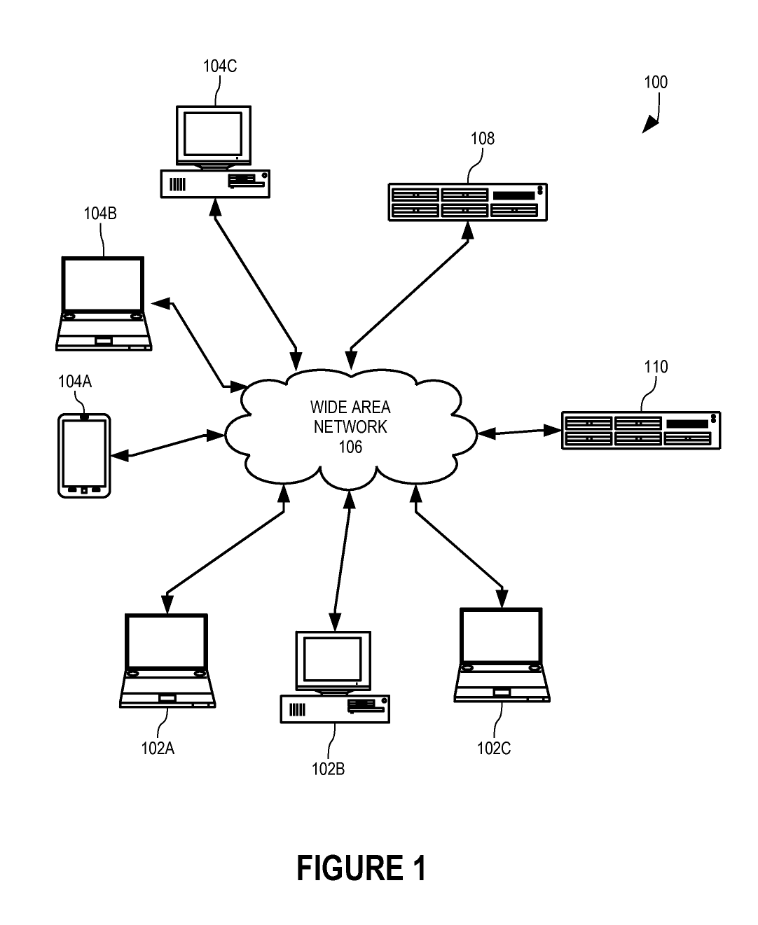

In accordance with the present invention, a forum server 108 (FIG. 1) distinguishes credentialed professional users of client devices 104A-C from lay users of client devices 102A-C and verifies that the credentialed professional users are credentialed through a credential authority server 110. Forum server 108, credential authority server 110, and client devices 102A-C and 104A-C communicate with one another through a wide area network 106, which is the Internet in this illustrative embodiment.

In a manner described in greater detail below, forum server 108 allows all users to be anonymous but requires actual, personal identification of the user. For professional users, such actual, personal identification allows verification of the user's professional credential through credential authority server 110. For all users, both professional and lay, such actual, personal identification enables detection and prevention of multiple user profiles being created by a single user.

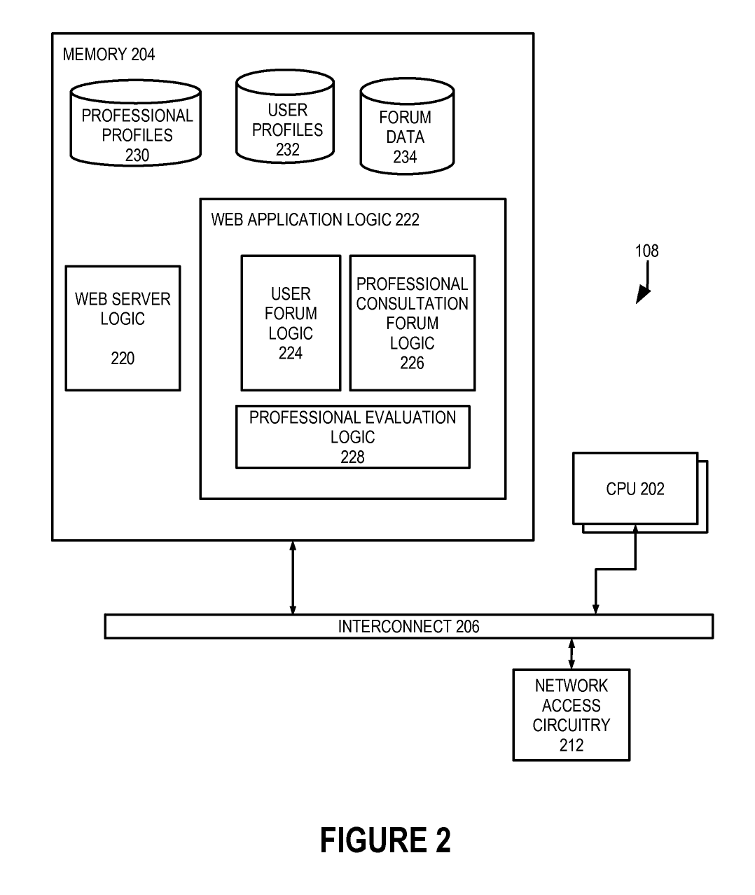

Forum server is shown in greater detail in FIG. 2. The specific structural details of forum server 108 are described below in greater detail. Briefly, web server logic 220 is logic that receives and serves requests according to the HTTP and HTTPS data transport protocols in a known and conventional manner. Web application logic 222 is logic that defines the specific handling of requests received by web server 220, including web page content to send to client devices 102A-C (FIG. 1) and 104A-C and processing of data received therefrom.

Web application logic 222 (FIG. 2) includes user forum logic 224 and professional consultation forum logic 226. User forum logic 224 defines the behavior of a forum in which both lay users and professional users can participate. Professional consultation forum logic 226 defines the behavior of a forum in only professional users can participate. Web application logic 220 also includes professional evaluation logic 228 that assesses quality of messages posted by professional users in either or both forums.

Forum server 108 also includes professional profiles 230, user profiles 232, and forum data 234.

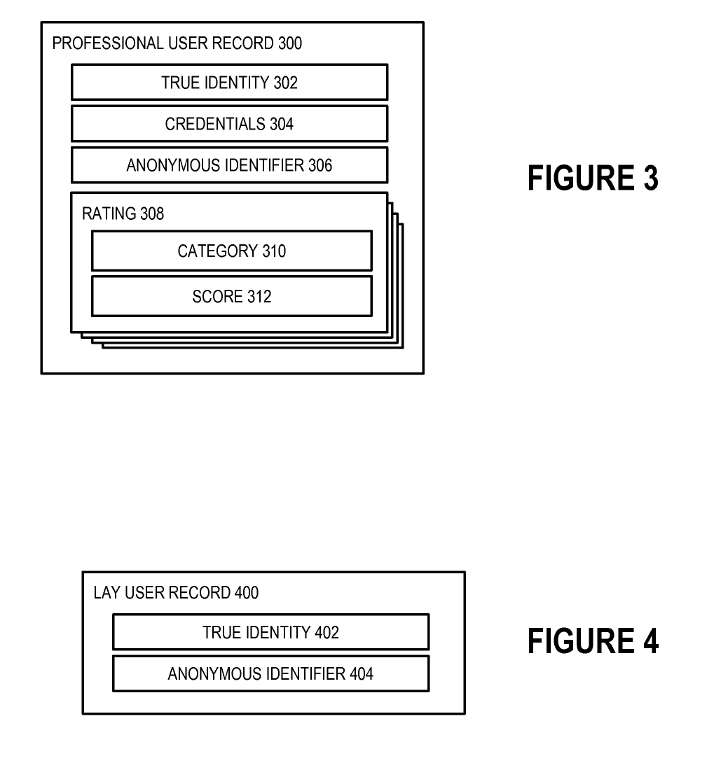

Professional profiles 230 include a number of professional user records such as professional user record 300 (FIG. 3). True identity 302 represents the true identity of the subject user, i.e., the user represented by professional user record 300. Credentials 304 represent the professional credentials of the subject user. Anonymous identifier 306 is the identifier by which the subject user is identified anonymously in the forums.

Professional user record 300 includes a number of ratings 308, each of which includes a category 310 and a score 312. In this embodiment, professional users are rated by other professional users. Such allows all users, both lay and professional, to see how well respected each of the professional users is within their professional community. Category 310 identifies a particular area of specialization within the subject profession and score 312 represents a cumulative score of the subject user according to peer feedback in that particular category.

User profiles 232 include a number of lay user records such as lay user record 400 (FIG. 4). True identity 402 represents the true identity of the subject user, i.e., the user represented by lay user record 400. Anonymous identifier 404 is the identifier by which the subject user is identified anonymously in the forums.

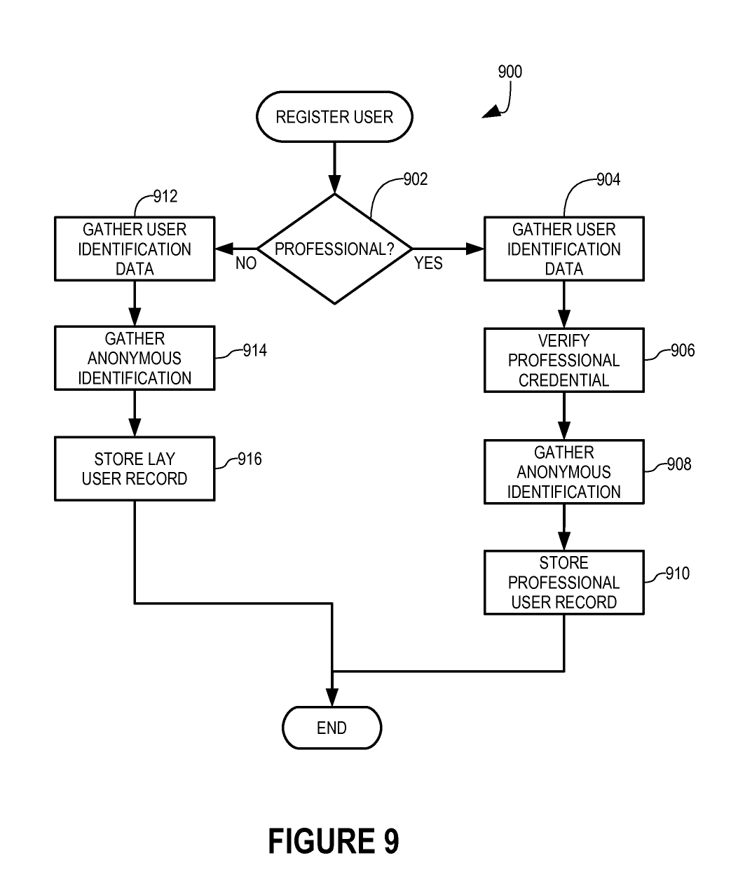

The manner in which web application logic 222 (FIG. 2) of forum server 108 registers a user to create either a lay user record or a professional user record is illustrated by logic flow diagram 900 (FIG. 9). In test step 902, web application logic 222 determines whether the user to be registered is a professional or a lay person. There are a number of ways in which web application logic 222 can make such a determination. In one embodiment, web application logic 222 provides a user interface wherein the user indicates an intention to register as a lay user or to register as a professional user. In another embodiment, the link by which a professional user is registered is sent to specific credentialed professionals as an invitation, perhaps sent to the credentialed professional using contact information provided by credential authority server 110.

If web application logic 222 determines that the user to be registered is a lay user, processing transfers from test step 902 to step 912, which is described more completely below. Conversely, if web application logic 222 determines that the user to be registered is a professional user, processing transfers from test step 902 to step 904.

In step 904, web application logic 222 gathers actual, personal identification data of the user. In this illustrative embodiment, web application logic 222 sends a web-based CGI form that requests such data from the user. To facilitate accurate identification of the user, the web page sent by web application logic 222 can require an image of photographic identification of the user and can require that the user be photographed by a web camera of the user's client device. Once received, the photographic identification of the user, such as a driver's license for example, can be graphically processed and analyzed to determine the identification's authenticity. In addition, web application logic 222 can employ optical character recognition (OCR) techniques to recognize text on the photographic identification, compare recognized text to personal identification supplied by the user, and use facial recognition techniques to determine that the image on the photographic identification and a facial image captured in the web cam are one and the same face.

In step 906, web application logic 222 verifies the professional credential of the user by cooperation with credential authority 110 (FIG. 1). For health care professionals, there are a number of web-based credential verification services. For example, the American Board of Medical Specialties maintains data regarding certification of doctors in a number of specialties. Similarly, for legal professionals, state bar organizations maintain data regarding membership and standing of legal professionals. In step 906 (FIG. 9), web application logic 222 queries credential authority server 110 using personal identification data received in step 904 to obtain data specifying the particular credentials held by the user. Unless the professional credential of the user is legitimate and in good standing, web application logic 222 refuses to register the user, terminating processing according to logic flow diagram 900.

In step 908, web application 222 gathers data representing an anonymous identifier of the user. In this illustrative embodiment, web application 222 sends a web page with a form in which the user can enter a preferred anonymous user name.

In step 910, web application 222 stores the data received in steps 904-908 in a new professional user record 300 (FIG. 3). True identity 302, credentials 304, and anonymous identifier 306 respectively store the data received in steps 904 (FIG. 9), 906, and 908. Initially, the new professional user record 300 (FIG. 3) includes no ratings 308.

As described above, processing by web application logic 222 transfers from test step 902 (FIG. 9) to step 912 if the user to be registered is not a professional user. Steps 912, 914, and 916 are directly analogous to steps 904, 908, and 910, respectively, except that a new lay user record 400 (FIG. 4) is created rather than a new professional user record. After either step 916 or step 910, processing according to logic flow diagram 900 completes.

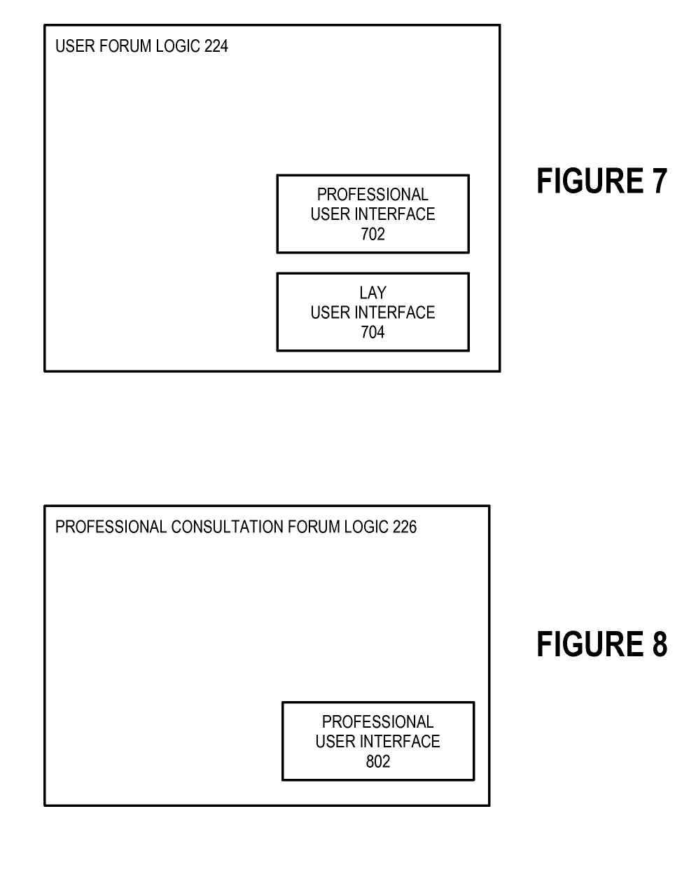

Returning to FIG. 2 briefly, web application logic 222 includes user forum logic 224 and professional consultation logic 226. User forum logic 224 is shown in greater detail in FIG. 7 and includes a professional user interface 702 and a lay user interface 704. Professional consultation forum logic 226 is shown in greater detail in FIG. 8 and includes professional user interface 802. In this illustrative embodiment, professional user interface 802 is directly analogous to professional user interface 702 (FIG. 7).

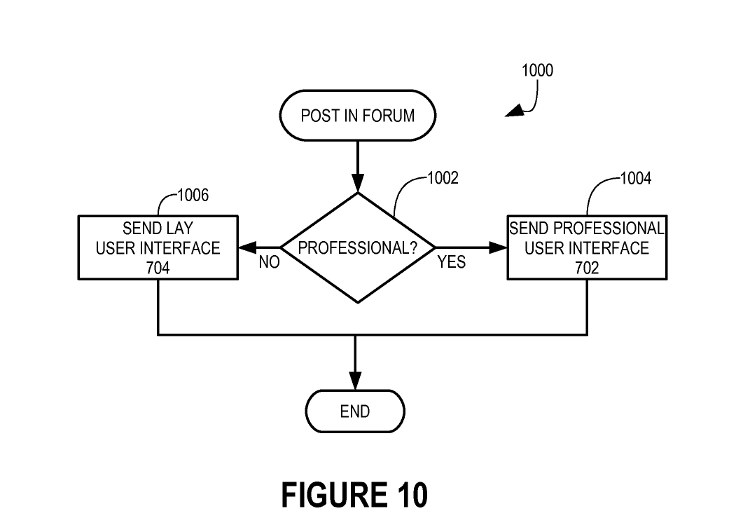

Web application logic 222 allows only registered professional users to participate in the professional consultation forum but allows both registered lay users and registered professional users to participate in the user forum. As shown in logic flow diagram 1000 (FIG. 10), web application logic 222 determines whether the user participating in the user forum is a professional user in test step 1002 and sends professional user interface 702 to the user in step 1004 if so. Otherwise, web application logic 222 sends lay user interface 704 to the user in step 1006.

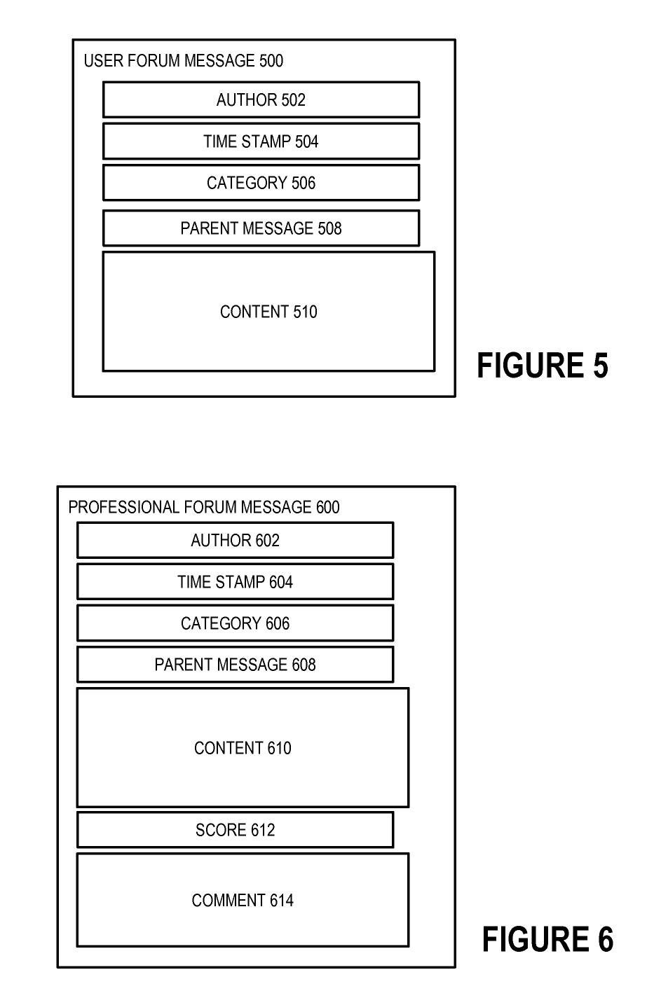

Lay user interface 704 includes prompts and user interface elements by which the user can enter fields of a user forum message stored in forum data 234 (FIG. 2) such as user forum message 500 (FIG. 5). Author 502 identifies the user entering the substance of the forum message as the source of user forum message 500. Time stamp 504 specifies the time at which user forum message 500 was created and is included automatically in user forum message 500 and is not specified by the user.

Category 506 specifies a particular category of forum topics to which the message pertains. In an illustrative embodiment in which the credentialed professionals are physicians, the categories are organized according to recognized and certified fields of physician specialization. If user forum message 500 is responsive to another message, parent message 508 identifies that message.

The substance of user forum message 500 authored by the user is stored in content 510. In this illustrative embodiment content 510 includes a brief text subject and can include rich text.

Forum data 234 (FIG. 2) also stores a number of professional forum messages such as professional forum message 600 (FIG. 6). The primary difference in professional user interfaces and professional forum message 600 is the ability to rate and comment upon other messages. Professional forum message 600 includes an author 602, a time stamp 604, a category 606, a parent message 608, and content 610 that are respectively analogous to author 502 (FIG. 5), time stamp 504, category 506, parent message 508, and content 510 of user forum message 500. However, professional forum message 600 also includes a score 612 and a comment 614.

Score 612 specifies a value the user places on the parent message, i.e., the message identified by parent message 608. In this illustrative embodiment, score 612 specifies a value between one and five and can be represented in a user interface as one to five stars. Five stars represents that the author, i.e., the user identified by author 602, “agrees completely” with the parent message; four stars represents that the author “agrees mostly” with the parent message; three stars represents that the author “neither agrees nor disagrees” with the parent message; two stars represents that that author “disagrees mostly” with the parent message; and one star represents that the author “disagrees completely” with the parent message. It should be appreciated that other rating scales can be used and represented by score 612.

Comment 614 stores textual data representing a comment of the author regarding the parent message, and can include rich text.

Professional user interface 802 (FIG. 8) allows all professionals to comment upon and rate all other messages since all other messages are from professional users. Professional user interface 702 can vary somewhat according to the specific design of user forum logic 224.

In one embodiment, professional user interface 702 is analogous to lay user interface 704, preventing professional users from rating or commenting upon messages authored by lay users and message authored by professional users. In another embodiment, professional user interface 702 allows a professional user to rate and comment upon only message authored by other professional users. In this embodiment, user interface elements by which the professional user can rate a parent message for storage in score 612 (FIG. 6) and comment upon the parent message for storage in comment 614 is only provided when the parent message is also a professional user message. In yet another embodiment, professional users are permitted to rate and comment upon all messages, whether lay or professional.

In some embodiments, lay user interface 704 (FIG. 7) limits the manner of participation of lay users. For example, in one embodiment, lay user interface 704 does not permit a lay user to respond in any message thread the lay user did not start. Such prevents users who are not verified to be credential professionals from offering what could be considered professional advice to other lay users.

In some embodiments, credentials 304 (FIG. 3) of a professional user can specify one or more recognized and certified fields of specialization and both user forum logic 224 (FIG. 2) and professional consultation forum logic 226 can restrict rating and commenting upon forum messages in categories for specialties for which the user is not certified. For example, a physician can be prevented from rating or commenting upon any messages in a category for oncology unless credentials 304 (FIG. 3) for that physician indicates that the physician is a certified oncologist.

As described briefly above, ratings 308 (FIG. 3) represent scores for a number of categories for a professional user. When a professional user's message is displayed by either user forum logic 224 (FIG. 2) or professional consultation forum logic 226 in a given category, a representation of the professional user's score 312 for that category is included in close proximity to the professional user's anonymous identifier 306. There are many ways to represent a rating score, including a number or color or character of stars or other icons or a numerical value.

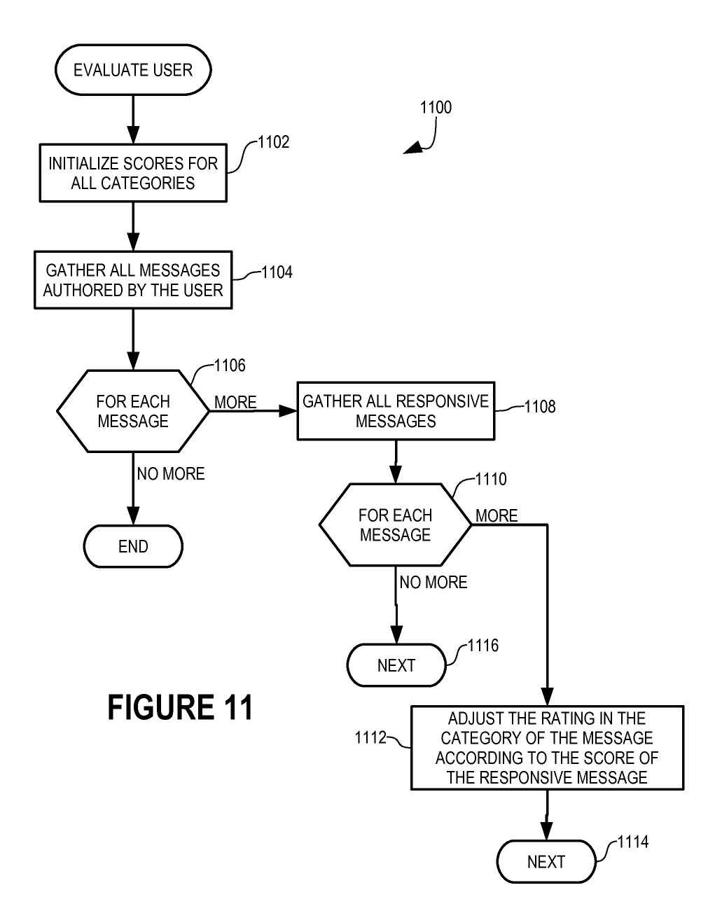

Periodically, professional evaluation logic 228 determines scores 312 for each professional user in the manner illustrated by logic flow diagram 1100 (FIG. 11) in this illustrative embodiment. In step 1102, professional evaluation logic 228 initializes scores for all categories for the subject user. In step 1104, professional evaluation logic 228 gathers all messages authored by the subject user, e.g., by reference to author 602 (FIG. 6) of all messages.

Loop step 1106 and next step 1116 define a loop in which professional evaluation logic 228 processes each of the messages authored by the user according to steps 1108-1114. In each iteration of the loop of steps 1106-1116, the particular message processed is sometimes referred to as the subject message.

In step 1108, professional evaluation logic 228 gathers all professional messages that are responsive to the subject message, e.g., by identifying all messages for which parent message 608 (FIG. 6) identifies the subject message.

Loop step 1110 (FIG. 11) and next step 1114 define a loop in which professional evaluation logic 228 processes each of the responsive messages gathered in step 1108 according to steps 1112. In each iteration of the loop of steps 1110-1114, the particular message processed is sometimes referred to as the subject responsive message.

In step 1112, professional evaluation logic 228 adjusts the user's score in the category of the subject message according to score 612 (FIG. 6) of the subject responsive message. In this illustrative example, each score 312 (FIG. 3) includes an accumulated score and a number of accumulated scores such that a mean score can be determined for each category.

Once all responsive messages for the subject message have been processed according to the loop of steps 1110-1114 (FIG. 11), processing by professional evaluation logic 228 transfers through next step 1116 to process the next of the user's messages. Once all messages of the user have been processed according to the loop of steps 1106-1116, processing by professional evaluation logic 228 completes and the user's aggregate scores in ratings 308 (FIG. 3) are known.

Forum server 108 is described briefly above in conjunction with FIG. 2. Forum server 108 includes one or more microprocessors 202 (collectively referred to as CPU 202) that retrieve data and/or instructions from memory 204 and execute retrieved instructions in a conventional manner. Memory 204 can include generally any computer-readable medium including, for example, persistent memory such as magnetic and/or optical disks, ROM, and PROM and volatile memory such as RAM.

CPU 202 and memory 204 are connected to one another through a conventional interconnect 206, which is a bus in this illustrative embodiment and which connects CPU 202 and memory 204 to network access circuitry 212. Network access circuitry 212 sends and receives data through computer networks such as wide area network 106 (FIG. 1).

A number of components of forum server 108 are stored in memory 204. In particular, web server logic 220 and web application logic 222, including user forum logic 224, professional consultation forum logic 226 and professional evaluation logic 228, are all or part of one or more computer processes executing within CPU 202 from memory 204 in this illustrative embodiment but can also be implemented using digital logic circuitry.

Web server logic 220 is a conventional web server. Web application logic 222 is content that defines one or more pages of a web site and is served by web server logic 220 to client devices such as client devices 102A-C and 104A-C to effect the behavior described above.

Client devices 102A-C and 104A-C are conventional, general-purpose computing devices that include conventional web browsers, though which respective users interact with forum server 108 in the manner described above.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for implementing one or more network-based discussion forums, the method comprising:
for each of one or more professionally credentialed users:
receiving personal identification data that personally identifies the user;
receiving anonymous identification data by which the user can be uniquely and anonymously identified;
sending at least part of the personal identification data through a computer network to a remotely located credential authority server; and
receiving credential data from the credential authority server through the computer network, wherein the credential data identifies one or more professional credentials of the user;
sending a feedback user interface to at least one of the professionally credentialed users by which the professionally credentialed users can rate one or more forum messages posted by other users; and
withholding the feedback user interface from all users that are not one of the professionally credentialed users.

2. The method of claim 1 wherein the feedback user interface enables professionally credentialed users to rate forum messages posted only by professionally credentialed users.

3. The method of claim 1 wherein the network-based discussion forums comprise:
a user discussion forum in which the professionally credentialed users can participate and in which users other than the professionally credentialed users can participate; and
a professional discussion forum in which only the professionally credentialed users can participate.

4. The method of claim 1 further comprising:
for each of the professionally credentialed users:
aggregating ratings from others of the professionally credentialed users evaluating messages posted by the professionally credentialed user to produce an aggregate evaluation score for the professionally credentialed user.

5. The method of claim 1 further comprising:
associating each message with one of two or more categories of subject matter; and
for each of the professionally credentialed users:
for each of the two or more categories:
aggregating ratings from others of the professionally credentialed users evaluating messages of the category that are posted by the professionally credentialed user to produce an aggregate evaluation score for the professionally credentialed user for the category.

6. A non-transitory computer readable medium useful in association with a computer that includes one or more processors and a memory, the computer readable medium including computer instructions that are configured to cause the computer, by execution of the computer instructions in the one or more processors from the memory, to implement one or more network-based discussion forums by at least:
for each of one or more professionally credentialed users:
receiving personal identification data that personally identifies the user;
receiving anonymous identification data by which the user can be uniquely and anonymously identified;
sending at least part of the personal identification data through a computer network to a remotely located credential authority server; and
receiving credential data from the credential authority server through the computer network, wherein the credential data identifies one or more professional credentials of the user;
sending a feedback user interface to at least one of the professionally credentialed users by which the professionally credentialed users can rate one or more forum messages posted by other users; and
withholding the feedback user interface from all users that are not one of the professionally credentialed users.

7. The computer readable medium of claim 6 wherein the feedback user interface enables professionally credentialed users to rate forum messages posted only by professionally credentialed users.

8. The computer readable medium of claim 6 wherein the network-based discussion forums comprise:
a user discussion forum in which the professionally credentialed users can participate and in which users other than the professionally credentialed users can participate; and
a professional discussion forum in which only the professionally credentialed users can participate.

9. The computer readable medium of claim 6 wherein the computer instructions are configured to cause the computer to implement one or more network-based discussion forums by at least also:
for each of the professionally credentialed users:
aggregating ratings from others of the professionally credentialed users evaluating messages posted by the professionally credentialed user to produce an aggregate evaluation score for the professionally credentialed user.

10. The computer readable medium of claim 6 wherein the computer instructions are configured to cause the computer to implement one or more network-based discussion forums by at least also:
associating each message with one of two or more categories of subject matter; and
for each of the professionally credentialed users:
for each of the two or more categories:
aggregating ratings from others of the professionally credentialed users evaluating messages of the category that are posted by the professionally credentialed user to produce an aggregate evaluation score for the professionally credentialed user for the category.

11. A computer system comprising:
at least one processor;
a computer readable medium that is operatively coupled to the processor;
network access circuitry that is operatively coupled to the processor; and
forum logic (i) that executes at least in part in the processor from the computer readable medium and (ii) that, when executed, causes the processor to implement one or more network-based discussion forums by at least:
for each of one or more professionally credentialed users:
receiving personal identification data that personally identifies the user;
receiving anonymous identification data by which the user can be uniquely and anonymously identified;
sending at least part of the personal identification data through a computer network to a remotely located credential authority server; and
receiving credential data from the credential authority server through the computer network, wherein the credential data identifies one or more professional credentials of the user;
sending a feedback user interface to at least one of the professionally credentialed users by which the professionally credentialed users can rate one or more forum messages posted by other users; and
withholding the feedback user interface from all users that are not one of the professionally credentialed users.

12. The computer system of claim 11 wherein the feedback user interface enables professionally credentialed users to rate forum messages posted only by professionally credentialed users.

13. The computer system of claim 11 wherein the network-based discussion forums comprise:
a user discussion forum in which the professionally credentialed users can participate and in which users other than the professionally credentialed users can participate; and
a professional discussion forum in which only the professionally credentialed users can participate.

14. The computer system of claim 11 wherein the forum logic is configured to cause the processor to implement one or more network-based discussion forums by at least also:
for each of the professionally credentialed users:
aggregating ratings from others of the professionally credentialed users evaluating messages posted by the professionally credentialed user to produce an aggregate evaluation score for the professionally credentialed user.

15. The computer system of claim 11 wherein the forum logic is configured to cause the processor to implement one or more network-based discussion forums by at least also:
associating each message with one of two or more categories of subject matter; and
for each of the professionally credentialed users:
for each of the two or more categories:
aggregating ratings from others of the professionally credentialed users evaluating messages of the category that are posted by the professionally credentialed user to produce an aggregate evaluation score for the professionally credentialed user for the category.
